(19) United States
(12) Patent Application Publication
(10) Pub. No.: US 2015/0266182 A1
(43) Pub. Date: Sep. 24, 2015

(54) Method And An Apparatus For Automatically Generating A Collision Free Return Program For Returning A Robot From A Stop Position To A Predefined Restart Position

(71) Applicant: ABB TECHNOLOGY LTD, Zürich (CH)

(72) Inventor: Morten Strandberg, Vasteras (SE)

(21) Appl. No.: 14/435,080

(22) PCT Filed: Oct. 11, 2012
(86) PCT No.: PCT/EP2012/070097

§ 371 Date: Apr. 10, 2015

(51) Int. Cl. B25J 9/16

(52) U.S. Cl. CPC B25J 9/1666; G05B 2219/40224; G05B 2219/40476

(57) ABSTRACT

A method and an apparatus for automatically generating a collision free return program for returning a robot from a stop position to a predefined restart position when the robot has been stopped during operation due to an error. The apparatus includes a receiving part adapted to receive a request for a recovery path and information on the stop position of the robot. A path generating part is adapted to generate a collision free recovery path for the robot upon receiving the request, based on the predefined restart position and the stop position of the robot using a path planning algorithm that generates robot positions connected by collision free path segments. A programming part is adapted to generate the return program based on the generated return path.

### FIELD OF THE INVENTION

The present invention relates to a method and an apparatus for automatically generating a collision free return program for returning a robot from a stop position to a predefined restart position when the robot has been stopped during operation due to an error.

### BACKGROUND OF THE INVENTION

Robust error handling is a difficult and time consuming problem for the robot programmer. When a robot in a robot cell stops due to an error, the robot has to be restarted again in a safe way. This involves moving the robot to a predefined restart position and then restarting the robot. Recovery paths can be programmed in advance, or an operator has to jog the robot to a position that is safe for restart.

It is important that the robot does not collide with any obstacle in the cell on its way from the stop position, i.e. the position in which the robot was stopped, to the restart position. Today, paths to be followed by the robot if it is stopped along the programmed path are preprogrammed during the programming of the robot. This means that a path must be programmed at each position along the path at which it is possible that the robot may stop, which is difficult and time consuming for the programmer.

In many applications, a plurality of robots works together in a robot cell. When one of the robots stops due to an error, all robots in the cell are stopped and accordingly all robots must be restarted and returned to their restart positions. It is important that the robots do not collide with each other or any obstacle in the cell on their way between the stop position and the restart position. However, with many robots in the cell and a small workspace, this operation is not easy to carry out without causing collisions. When there are several robots in the cell it is extremely difficult to preprogram the recovery paths. Some customers demand that the programs are written so that the robots can recover from errors almost anywhere in the program. This demand increases the programming time with several weeks, and leads to large programs that are difficult to comprehend.

EP1625 918 discloses a programming device connected to a robot operated based on a teaching program, for making a returning program for returning the robot from a stop position where the robot during operation is stopped at a waiting position. An off-line programming device is used as the programming device for making the return program. The programming device includes an attribute data providing part adapted to provide attribute data to each teaching position included in the teaching program, the attribute data representing whether each teaching position may be used for a teaching point of the returning program or not, a storing part adapted to store at least one teaching program capable of being executed by the robot, a receiving part adapted to receive data of the stop position of the robot and information on a block of the program executed when the program was stopped by the emergency stop, a selecting part reading a teaching program from the storing part, sequentially searching the teaching positions from the block of the teaching program in an executing direction of the program, or a backward direction, and selecting the teaching points used for the returning program based on the attribute data of the teaching positions, a programming part adapted to make the returning program based on the teaching points selected by the selecting part, an interference judging part simulating the operation of the robot based on the returning program so as to judge whether interference occurs between the robot and the object around the robot, and a transferring part adapted to transfer the returning program to the robot if the interference judging part judges that interference between the robot and the objects around the robot does not occur. If the interference judging part judges that interference between the robot and the objects does occur, the returning program is corrected by the operator. In order to correct the returning program, the operator may insert new teaching points other than the teaching points included in the teaching program.

A drawback with this method is that the programmer has to add attribute data to each teaching point during programming of the robot, which is time consuming. A further drawback with this method is that the operator must correct the returning program manually if interference between the robot and the objects does occur. Further, this method is not suitable for determining returning paths for a plurality of robots working together in a robot cell.

### SUMMARY OF THE INVENTION

One object of the present invention is to provide an improved method and apparatus for automatically generating a collision free return program for returning a robot from a stop position to a predefined restart position, which alleviates the drawbacks mentioned above.

According to one aspect of the invention, this object is achieved by the method for automatically generating at least one collision free return program.

The method comprises sending a request for a recovery path when the robot has been stopped, generating a collision free recovery path from the stop position to the restart position using a path planning algorithm that generates robot positions connected by collision free path segments, and generating a robot program including movement instructions for returning the robot to the restart position based on the determined recovery path.

According to the invention, a collision free recovery path is automatically generated when the robot is stopped due to an error by means of a path planning algorithm based on the predefined restart position and the stop position for the robot. This means that the error handling has no connection to the teaching program, and the teaching program does not contain any information regarding the recovery path, other than the restart position. Thus, the programming time is significantly reduced and the robot programs becomes smaller and easier to comprehend. The path planning algorithm allows automatic generation of a collision-free path from the start position to the restart position. Further, the operator does not have to correct the returning program if interference occurs between the robot and the object. This dramatically simplifies the error handling. The error handling becomes easy and robust. Further, the method according to the invention allows the robot to be restarted from any position along the programmed path.

Algorithms for automatic path planning of collision-free paths have been extensively studied in the academia for more than three decades. There are algorithms today that solve difficult path planning problems within a few seconds. There also exist commercially available software libraries that can be used.

So far, however, path planning algorithms have been little used in on-line scenarios. When it comes to industrial robotics, there are very few examples. There are some reasons for that. One reason is that the running time for a single query is very hard to predict, ranging from fractions of a second to a couple of minutes. Robot applications are often very sensitive to disturbances in the timing. Thus, it is preferable that the time period for performing a certain task always is the same, independent of when it is performed. Accordingly, path planning algorithms are not useful for on-line path planning of an industrial robot. Further, it is difficult to give any guarantees on the quality of the generated path. The found path can look good nine times out of ten, but there can also be paths where the robot takes unnecessary detours.

According to the invention, the recovery path is generated on-line, i.e. when the robot is stopped due to an error. However, none of these drawbacks are a problem in the context of error recovery. When recovering from an error, it does not matter whether the path looks good or not. Nor does it matter if it takes 1 second or 60 seconds to find the recovery path. All that matters is that the path is collision free.

According to an embodiment of the invention, the path planning algorithm is a sampling-based motion planning algorithm. This type of motion planning algorithm has the advantages of being relatively easy to implement, while being both general and capable of solving difficult path planning problems. The sampling based motion planning algorithms samples the collision-free configuration space (the joint space of the robot) and builds a graph or a tree representation of it. Each robot position is a node in the representation, and edges between the nodes represent collision free path segments. Various heuristic search algorithms are used for guiding the exploration of the free configuration space. The result from a query is typically a piecewise linear path from the start position to the goal position.

According to an embodiment of the invention, the path planning algorithm includes a heuristic search algorithm that searches for robot positions connected by collision free path segments in the configuration space of the robot. The configuration space is the set of positions reachable by a robot's end-effector. The joint parameters of the robot are used as generalized coordinates to define its configurations. The set of joint parameter values is called the joint space. Thus, the configuration space is defined by the joint space of the robot. A heuristic search algorithm is an algorithm that searches for a collision free path between two positions based on a few simple rules. A heuristic algorithm is a method that might not always find the best solution, but is guaranteed to find a good solution in reasonable time.

According to an embodiment of the invention, the path planning algorithm comprises:

generating possible positions in the configuration space of the robot,

determining whether it is possible to connect collision free path segments between the generated positions based on a model of the robot and its environment,

discarding the positions which cannot be connected by collision free path segments, and

generating a collision free path from the stop position to the restart position based on the positions which can be connected by collision free path segments.

According to an embodiment of the invention, the method comprises computing minimum distances between the generated positions and the environment of the robot, and determining whether it is possible to connect the positions with collision free path segments based on the computed minimum distances between the generated positions and the environment of the robot. Algorithms for computing the minimum distance between two geometric objects are typically more consuming than algorithms that only determine interference. However, minimum-distance information is necessary in order to guarantee that a path segment is collision free.

According to an embodiment of the invention, the method is adapted for returning a plurality of robots to predefined restart positions when the robots have been stopped due to an error, the method comprising generating a collision free recovery path for each of the robots upon receiving said request, using a path planning algorithm that generates robot positions connected by collision free path segments based on the predefined restart positions and the stop positions for the robots. This embodiment of the invention makes it possible to automatically determine collision free recover paths for a plurality of robots, without any interference of the operator. The path planning algorithm is used for providing collision free recover paths for the robots in order to avoid collisions between the robots.

According to another aspect of the invention, the object is achieved by an apparatus for automatically generating at least one collision free return program.

The apparatus comprises:

a receiving part adapted to receive a request for a recovery path and information on the stop position of the robot,

a path generating part adapted to generate a collision free recovery path for the robot upon receiving said request, based on the predefined restart position and the stop position of the robot using a path planning algorithm that generates robot positions connected by collision free path segments, and

a programming part adapted to generate the return program based on the generated return path.

According to an embodiment of the invention, the path generating part is adapted to use a sampling-based motion planning algorithm to generate a collision free recovery path.

According to an embodiment of the invention, the path generating part comprises a position generator adapted to generate possible positions in the configuration space of the robot, and a collision-checking module adapted to determine whether path segments between the generated positions are collision free based on a model of the robot and its environment.

According to an embodiment of the invention, the collision-checking module is adapted to compute the minimum distance between the generated positions and the environment of the robot, and to determine whether it is possible to connect the positions with collision free path segments based on the computed minimum distances between the generated positions and the environment of the robot.

According to an embodiment of the invention, the apparatus is adapted for automatically generating collision free return programs for returning a plurality of robots from their stop positions to predefined restart positions, the receiving part is adapted to receive a request for recovery paths for a plurality of robots and information on the stop positions of the robots, said path generating part is adapted to generate collision free recovery paths for the robots based on the predefined restart positions and the stop positions of the robot and models of the robots and their environment, and the programming part is adapted to generate return programs for the robots based on the generated return paths.

According to an embodiment of the invention, the robot comprises a robot controller for controlling the movements of the robot and the apparatus is integrated in the robot controller. Advantages achieved by this embodiment is that no external server is needed, there is less communication with external units, and it is easier to assure that the algorithm uses a correct geometric model for the robot.

### BRIEF DESCRIPTION OF THE DRAWINGS

The invention will now be explained more closely by the description of different embodiments of the invention and with reference to the appended figures.

FIG. 1 shows an example of an industrial robot following a programmed path based on a teaching program, and the restart position of the robot.

FIG. 2 shows a block diagram of an apparatus for automatically generating a collision free return program for a robot according to an embodiment of the invention.

FIG. 3 shows a flowchart of a method for automatically generating a collision free return program for returning a robot from a stop position to a predefined restart position according to an embodiment of the invention.

FIG. 4 shows a flowchart of an example of a path planning algorithm.

### DETAILED DESCRIPTION OF THE INVENTION

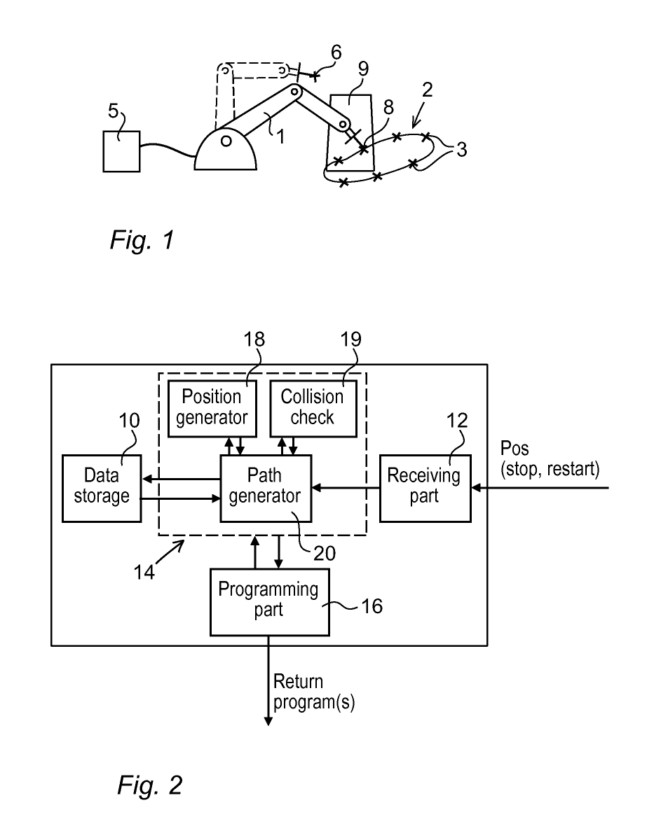

FIG. 1 shows an industrial robot 1 following a programmed path 2, including a plurality of programmed positions 3, based on a teaching program. The teaching program is run on a robot controller 5, which controls the movements of the robot. The figure also shows the robot (dashed lines) in a restart position 6. The restart position of the robot is defined in advance and is the position to which the robot must return when it has recovered after an emergency stop due to an error. If the robot cell includes more than one robot, a restart position is defined for each robot in the cell. The restart position is the position to which the robot is moved when the robots in the cells have been stopped due to an error. The robot has been stopped in a stop position 8. The robot is located in a robot cell including a workstation 9. The robot should be moved from the stop position 8 to the restart position 6 without colliding with the workstation 9. If the robot cell includes more than one robot, all robots are stopped during an emergency stop.

FIG. 2 shows a block diagram of an apparatus for automatically generating a collision free return program for returning the robot from a stop position 8 to a predefined restart position 6 according to an embodiment of the invention. The apparatus comprises data storage 10 for storing a model of the robot and the environment of the robot, including all obstacles that the robot may collide with, such as the workstation 9. If the robot cell includes more than one robot, the data storage includes models of all the robots in the robot cell. The apparatus comprises a receiving part 12 adapted to receive a request for a recovery path and information on the stop position 8 of the robot and the restart position 6. Alternatively, information on the restart position is stored in the data storage 10.

The apparatus further includes a path generating part 14 adapted to generate a collision free recovery path for the robot 1 upon receiving the request, and a programming part 16 adapted to generate a return program based on the generated return path. If the robot cell includes more than one robot, the path generating part 14 is adapted to generate collision free recovery paths for all the robots in the robot cell upon receiving the request in order to avoid collisions between the robots when they return to their restart positions, and the programming part 16 is adapted to generate return programs for all of the robots in the robot cell based on the generated return paths.

The path generating part 14 is adapted to use a path planning algorithm, such as a sampling-based motion planning algorithm, to generate the collision free recovery path or paths. The path planning algorithm generates new robot positions connected by collision free path segments. The path generating part 14 comprises a position generator 18 adapted to generate possible positions in the configuration space of the robot, a collision-checking module 19 adapted to determine whether the path segments between the generated positions are collision free based on the model of the robot and its environment, and a path generator 20 that generates a collision free path based on the generated positions and the result of the collision check. The position generator 18 may generate the positions in a randomized way or according to a predetermined pattern.

The apparatus according to the invention can be implemented in the robot controller or on a separate server computer. For example, the path planning algorithm is running as a server application that receives requests via sockets. Client code written in a robot language, such as RAPID, asks the server for a path from the current position to a desired goal position. If the server finds a path, a recovery program written in the robot language is generated and loaded dynamically. If the cell contains several robots, then a recovery program is generated for each robot, together with necessary synchronization instructions.

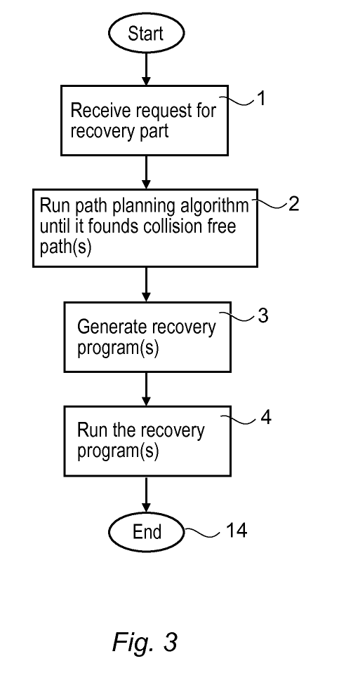

FIG. 3 shows a flowchart of a method for automatically generating a collision free return program for returning a robot from a stop position to a predefined restart position according to an embodiment of the invention. Restart positions for the robots in the cell have been defined in advanced. The method includes the following steps:

Block 1: Receiving a request for a recovery path when the robot has been stopped. When the robot/robots are stopped due to an error, the robot controller/controllers sends the current positions, i.e. the stop position, and the restart positions for all of the robots in the cell to a path planning algorithm, which for example is run on a server computer.

Block 2: The path planning algorithm determines recovery paths from the stop positions to the restart positions, which are collision free, for all of the robots. The recovery paths include robot positions connected by collision free path segments. The path planning algorithm is run until it finds collision free paths for all of the robots. The generated robot positions are new, and are not a part of the points on the teaching path.

The path planning algorithm generates possible positions in the configuration space of the robot, determines whether it is possible to connect collision free path segments between the generated positions based on a model of the robot/robots and the environment, discards the positions which cannot be connected by collision free path segments, and generates a collision free path/paths from the stop position to the restart position based on the positions which can be connected by collision free path segments. The algorithm searches in the 6-dimensional joint-space in the configuration space of the robot/robots to find positions which can be connected by collision free path segments.

Block 3: A recovery program, including movement instructions for returning the robot/robots to the restart position/positions, is generated based on the determined recovery path/paths. If the recovery program is generated on a separate server unit, the recovery program is returned to the robot controller/controllers.

Block 4: The recovery program is run on the robot controller and the robots are moved to their restart positions according to the recovery paths.

There exist several path planning algorithms which can be used for this purpose, for example, RRT (Rapidly exploring, Random Trees) and PRM (Probabilistic Road Map). The RRT algorithm is, for example described in an article in Proc. 2000 IEEE Int'l Conf. on Robotics and Automation (ICRA 2000), “RRT-Connect: An Efficient approach to single-Query Path Planning”, written by James J. Kuffner and Steven M. LaValle.

Preferably, the path planning algorithm is a sampling-based motion planning algorithm as described in the book “Planning Algorithms” by Steven M. LaValle, Chapter 5, Sample-based motion planning, 2006. Available for downloading at http://planning.cs.uiuc.edu/.

How to do collision checking of robots is, for example, known from an article written by Fabian Schwarzer, Mitul Saha and Jean-Claude Latombe, “Exact collision checking of robot paths”, department of Computer Science, Stanford University, and available for downloading at http://robotics.stanford.edu/. From this article, the following method for determining a collision free path is known.

The robot links are the mechanical parts connecting the joins of the robot. Given two robot positions p1 and p2, the smallest distance between a robot link and the environment is d1 in the position p1 and d2 in the position p1. If the entire movement of the robot link is delimited by D(p1, p2) when the robot moves from p1 to p2, then the path segment is collision free for the robot link if D(p1, p2)<d1+d2.

In the article it is shown how to calculate D(p1, p2) for each link of the robot. If the inequality is not fulfilled, it is necessary to divide the path segment into smaller sub segments. This is repeated until either the inequality is fulfilled for all sub segments, or a collision is found. Thus, it is necessary to determine the smallest distance between the robot and its environment in the generated positions in order to safely determine whether the path segment is collision free or not.

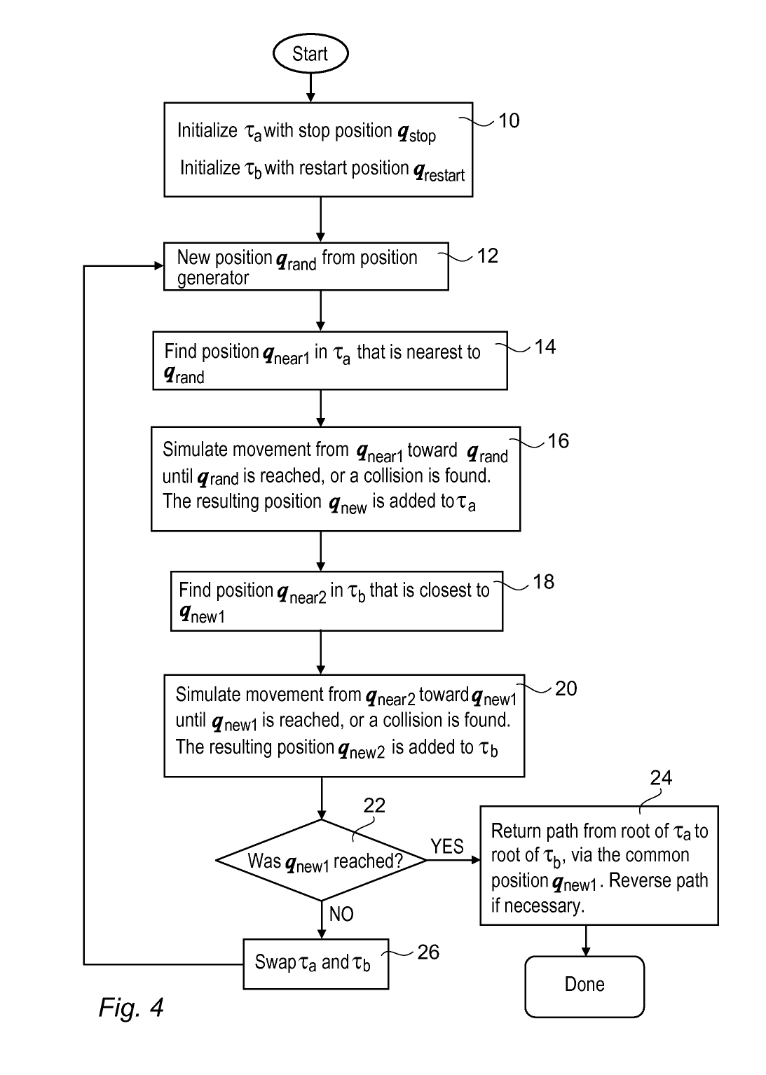

FIG. 4 shows a flowchart of an example of a path planning algorithm. The figure shows a variation of the RRT Connect algorithm as described by Kuffner and LaValle. The algorithm works with two trees in the configuration space [symbol] ₐ and [symbol] _{b}. The first tree is rooted in the stop position and the second tree is rooted in the restart position. The algorithm simultaneously explores the free configuration space and tries to connect the two trees.

In a first step the configuration space τₐ is initialized with the stop position qₛₜₒₚ of the robot, and the configuration space τ_{b} is initialized with the restart position q_{restart,} block 10. In a second step, the position generator 18 generates a new position q_{rand,} block 12. The algorithm searches for the position qₙₑₐᵣ₁ in the configuration space τₐ that is nearest to q_{rand,} block 14. The movement from qₙₑₐᵣ₁ toward q_{rand} is simulated until q_{rand} is reached, or a collision is found. The resulting position q_{new1} is added to the configuration space τₐ, block 16. The algorithm searches for the position qₙₑₐᵣ₂ in the configuration space τ_{b} that is nearest to q_{new1}, block 18. The movement from qₙₑₐᵣ₂ toward q_{new1} is simulated until q_{new1} is reached, or a collision is found. The resulting position q_{new2} is added to the configuration space τ_{b}, block 20. It is determined whether q_{new1} was reached or not, block 22. If q_{new1} was reached, a return path from root of τₐ to root of τ_{b}, via the common position q_{new1} has been found, block 24. Reverse path if necessary. If q_{new1} was reached, τₐ and τ_{b} are swapped, and the steps from block 12 to 22 are repeated, block 26.

The present invention is not limited to the embodiments disclosed but may be varied and modified within the scope of the following claims. For example, other types of path planning algorithms can be used.

1. A method for automatically generating at least one collision free return program for returning at least one robot from a stop position to a predefined restart position when the robot has been stopped during operation due to an error, the method comprising:
sending a request for a recovery path when the robot has been stopped,
generating at least one recovery path for the at least one robot upon receiving said request, and
generating a robot program including movement instructions for returning the robot to its restart position based on the determined recovery path.
characterized in that the method comprises:
storing a model of the robot and the environment of the robot including obstacles that the robots may collide with,
generating the recovery path for the robot using a path planning algorithm that generates robot positions connected by collision free path segments, the path planning algorithm including:
generating possible positions in the configuration space of the robot,
determining whether it is possible to connect collision free path segments between the generated positions based on said model of the robot and its environment,
discarding the positions which cannot be connected by collision free path segments, and
generate a collision free path from the stop position to the restart position based on the positions which can be connected by collision free path segments.

2. The method according to claim 1, wherein the path planning algorithm is a sampling-based motion planning algorithm.

3. The method according to claim 1, wherein the path planning algorithm includes a heuristic search algorithm that searches for robot positions connected by collision free path segments in the configuration space of the robot.

4. The method according to claim 1, wherein the method comprises computing minimum distances between the generated positions and the environment of the robot, and determining whether it is possible to connect the positions with collision free path segments based on the computed minimum distances between the generated positions and the environment of the robot.

5. The method according to claim 1, wherein the method is adapted for returning a plurality of robots to predefined restart positions when the robots have been stopped due to an error, the method comprising generating a collision free recovery path for each of the robots upon receiving said request, using a path planning algorithm that generates robot positions connected by collision free path segments based on the predefined restart positions and the stop positions for the robots.

6. An apparatus for automatically generating at least one collision free return program for returning at least one robot from its stop position to a predefined restart position when the robot has been stopped during operation due to an error, wherein the apparatus comprises:
a receiving part adapted to receive a request for a recovery path and information on the stop position of the robot,
a path generating part adapted to generate a recovery path for the robot upon receiving said request, and
a programming part adapted to generate the return program based on the generated return path, characterized in that the apparatus comprises data storage for storing a model of the robot and the environment of the robot including obstacles that the robot may collide with, and the path generating part is adapted to generate a collision free recovery path for the robot using a path planning algorithm that generates robot positions connected by collision free path segments, comprising a position generator adapted to generate possible positions in the configuration space of the robot, and a collision-checking module adapted to determine whether path segments between the generated positions are collision free based on said model of the robot and its environment, to discard the positions which cannot be connected by collision free path segments, and to generate a collision free path from the stop position to the restart position based on the positions which can be connected by collision free path segments.

7. The apparatus according to claim 6, wherein the path generating part is adapted to use a sampling-based motion planning algorithm to generate a collision free recovery path.

8. The apparatus according claim 6, wherein the collision-checking module is adapted to compute the minimum distance between the generated positions and the environment of the robot, and to determine whether it is possible to connect the positions with collision free path segments based on the computed minimum distances between the generated positions and the environment of the robot.

9. The apparatus according to claim 6, wherein the apparatus is adapted for automatically generating collision free return programs for returning a plurality of robots from their stop positions to predefined restart positions, the receiving part is adapted to receive a request for recovery paths for a plurality of robots and information on the stop positions of the robots, said path generating part is adapted to generate collision free recovery paths for the robots based on the predefined restart positions and the stop positions of the robot and models of the robots and their environment, and the programming part is adapted to generate return programs for the robots based on the generated return paths.

10. The apparatus according to claim 6, wherein the robot comprises a robot controller for controlling the movements of the robot and the apparatus is integrated in the robot controller.
